(19) United States
(12) Patent Application Publication
(10) Pub. No.: US 2008/0309157 A1
(43) Pub. Date: Dec. 18, 2008

(54) Stud for a Crawler Pertaining to Crawler-Type Vehicles, Especially Ski Slope Grooming Vehicles or Appliances for Tracing Cross-Country Ski Runs

(76) Inventors: Martin Runggaldier, St. Christina (IT); Volker Pahl, Vinti (IT)

Correspondence Address: FROMMER LAWRENCE & HAUG, 745 FIFTH AVENUE- 10TH FL., NEW YORK, NY, 10151, US

(21) Appl. No.: 11/793,831

(22) PCT Filed: Dec. 20, 2005
(86) PCT No.: PCT/EP05/13744

§ 371 Date: Mar. 7, 2008

(30) Foreign Application Priority Data
Dec. 22, 2004 (AT) A2144/2004
Oct. 21, 2005 (EP) 05022983.0

(51) Int. Cl. B62D 55/08; B62D 55/26

(52) U.S. Cl. 305/47

(57) ABSTRACT

A stud for a crawler pertaining to crawler-type vehicles, especially ski slope grooming vehicles or appliances for tracing cross-country ski runs, the stud having a carrier provided with a portion for mounting an inserted bar, wherein the mounting portion has two parallel legs interconnected by a connecting element arranged on the crawler, and arranged at an angle, at a distance from the bearing surface of the stud; wherein the bar is partially glued and/or welded in the mounting portion.

The invention relates to a stud for a crawler pertaining to crawler-type vehicles, especially ski slope grooming vehicles or appliances for tracing cross-country ski runs, comprising a carrier with a portion for mounting an inserted bar, said mounting portion comprising two substantially parallel legs interconnected by a connecting element arranged spaced away from the contact surface of the stud on the crawler by a spacing d. The invention relates furthermore to a crawler-type vehicle, especially ski slope grooming vehicle or appliance for tracing cross-country ski runs comprising a crawler stud as aforementioned and at least one crawler sprocket.

### BACKGROUND OF THE INVENTION

Generic studs are employed in crawler-type vehicles since conventional one-part studs, made of aluminum, for instance, quickly wear out in operation. One-part studs made of steel, for instance, are too heavy for normal operation. This is why in prior art multi-part studs are used in which a bar, for example a so-called wear bar in the form of a toothed bar of steel in a carrier made of a lighter material, particularly a light alloy such as e.g. aluminum or a plastics material is inserted into the mounting portion of the carrier. As a rule such bars are interconnected in the mounting portion of the carrier in prior art by mechanical fasteners such as e.g. rivets, bolts or pins to prevent the bar from dropping out of place or being displaced sideways.

The drawback with such studs is that the studs often break due to the weakening of the material in the portion of the mechanical fasteners.

### SUMMARY OF THE INVENTION

An object of the invention is thus to develop a stud less liable to break.

In accordance with the invention this is achieved in that the bar is bonded and/or welded at least partially in the mounting portion. In the scope of the invention the bar is to be connected to the carrier such that no mechanical fasteners such as bolts or pins are needed which usually weaken the studs in thus making them more susceptible to breakage. A further aspect of the invention provides for a stud for crawler-type vehicles, especially ski slope grooming vehicles or appliances for tracing cross-country ski runs, comprising a carrier with a portion for mounting an inserted bar, said mounting portion comprising at least two legs at an angle α to each other, the bar being bonded and/or welded at least partially to the mounting portion. Optionally it is provided for that one leg is arranged spaced away from the contact surface of the stud on the crawler, it having been discovered in such a case that it is favorable when the bar is in contact with the two legs at least portionwise.

As discovered favorable in the case of a stud for a crawler on crawler-type vehicles, especially ski slope grooming vehicles or appliances for tracing cross-country ski runs, comprising a carrier with a portion for mounting an inserted bar, said mounting portion comprising two substantially parallel legs interconnected by a connecting element arranged spaced away from the contact surface of the stud on the crawler, the two legs and the connecting element form substantially a U-shaped groove cross-sectionally, as a result of which the probability of the stud breaking is less since conventional studs tend to break particularly at locations where the material is weakened, for example, due to spot or through drilled holes. It has furthermore been discovered to be favorable when the bar extends down to the bottom of the groove, since the mechanical forces occurring in operation are better distributed over the bar in thus further reducing the probability of the bar breaking.

It has been discovered to be particularly favorable when the stud is configured in all embodiment variants so that the bar is connected to the mounting portion of the carrier without mechanical fasteners such as bolts, rivets or pins.

In one preferred embodiment variant of the stud in accordance with the invention the insertion depth of the bar in the mounting portion of the carrier is smaller than roughly a third of the height of the carrier, preferably smaller than roughly a fifth of the height of the carrier.

In addition, it has been discovered to be favorable to insert the bar at least partially in the mounting portion of the carrier positively connected, it being particularly favorable to insert the bar in the mounting portion of the carrier friction-locked at least partially, achievable, for instance, by clinching the carrier to a bar inserted positively connected or also by inserting a bar in the mounting portion of the carrier in a dead fit. This can prove to be favorable particularly in the portion where the sprocket of the crawler-type vehicle meshes with the bar.

Bonding the bar in the mounting portion of the carrier can be done in various ways. For instance, use can be made in prior art of a physically curing adhesive or chemically curing adhesive. Particularly useful as a physically curing adhesive in accordance with the invention is a solvent-based wet adhesive, dispersion adhesive, hot melt adhesive, contact adhesive, keying adhesive or a plastisol. Favorable chemically curing adhesives are cyanacyrylate adhesives, methylmethacrylate adhesives, anaerobic hardening adhesives, radiation hardening adhesives, phenolic formaldehyde resin adhesives, silicones, polymide adhesives, epoxy resin adhesives and polyurethane adhesives. In one preferred example embodiment use is made of a urethane and methalcrylate-based anaerobic hardening adhesive. Using anaerobic hardening adhesives is favorable and thus in accordance with the invention to the extent that they can be applied to joints with good hardening even without an oxygen supply. This is why it is favorable to apply an anaerobic hardening adhesive to the mounting portion of the carrier and then to insert the bar. Hardening occurs completely even in he absence of oxygen. Apart from this, adhesives of this kind feature particularly favorable adhesive properties, since they feature ideal bonding properties also over a very broad temperature range. This is why such adhesives are often employed for metal-to-metal connections. In accordance with the invention, however, other adhesives are just as conceivable, particularly when they feature similar good thermal properties and similar good metal to metal bonding properties.

The invention relates furthermore to methods of producing a stud for a crawler pertaining to crawler-type vehicles, especially ski slope grooming vehicles or appliances for tracing cross-country ski runs comprising a carrier with a portion for mounting an inserted bar, particularly studs of the aforementioned kind, bar and carrier being made of differing materials, particularly metals or alloys.

Known in existing prior art is merely a weld between metals or alloys of the same kind. It was not until the development of cold metal transfer (CMT) welding that it was even conceivable to weld differing materials such as, for example, aluminum and steel together. This method, described for the first time in WO 01/34336, is a discontinuous method of “mild” welding by alternating a heating up and a cooling down phase.

The invention is based on having surprisingly discovered that the bar, preferably made of steel and at least 3 mm thick, can now be welded to a carrier made of aluminum by means of CMT welding as well as by means of friction welding. Welding aluminum to steel, as described in the aforementioned PCT application, was hitherto employed only in automotive engineering. The bars in accordance with the invention, preferably of steel, are now welded to a carrier, preferably of aluminum. Such welds have been discovered to be extremely rugged even in prolonged operation of for crawler-type vehicles, especially ski slope grooming vehicles or appliances for tracing cross-country ski runs.

Friction welding as detailed below has also been surprisingly discovered to be suitable for connecting aluminum to steel in the present case.

### BRIEF DESCRIPTION OF THE DRAWINGS

Further advantages will now be detailed with reference to the Figs. in which:

FIG. 1 is a diagrammatic representation of a crawler-type vehicle in accordance with the invention,

FIG. 2 is a diagrammatic representation of part of a crawler in accordance with the invention as viewed from above,

FIG. 3 is a diagrammatic representation of a stud including bar and carrier in an exploded view,

FIG. 4 is a diagrammatic representation of part on one example embodiment of a crawler where a sprocket meshes with the middle of the stud, and

FIGS. 5a-5c are diagrammatic representations of three example embodiments of bonded studs in accordance with the invention viewed in cross-section.

FIGS. 6a-6d are diagrammatic representations of four example embodiments of welded studs in accordance with the invention viewed in cross-section, and

FIG. 7 is a diagrammatic representation of a stud with an inserted bar prior to welding,

FIGS. 8a, 8b are diagrammatic representations of two different methods of friction welding for connecting the stud to the bar.

### DETAILED DESCRIPTION OF THE INVENTION

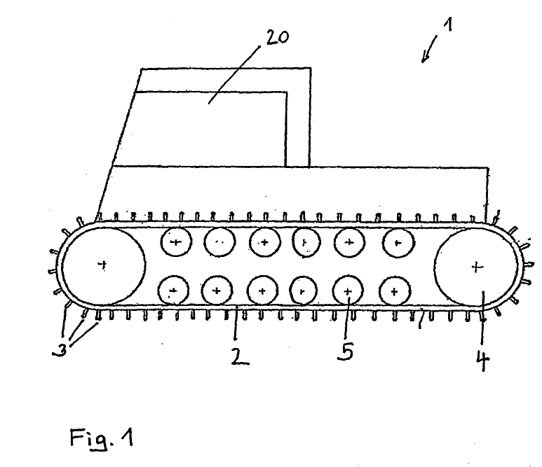

Referring now to FIG. 1 there is illustrated a crawler-type vehicle 1 in accordance with the invention comprising a crawler 2, sprockets 4 as well as idlers 5. The crawler-type vehicle 1 is controlled by a driver seated in the cab 20. One such crawler 2 comprises a plurality of studs 3 in accordance with the invention which in operation bite into the snow.

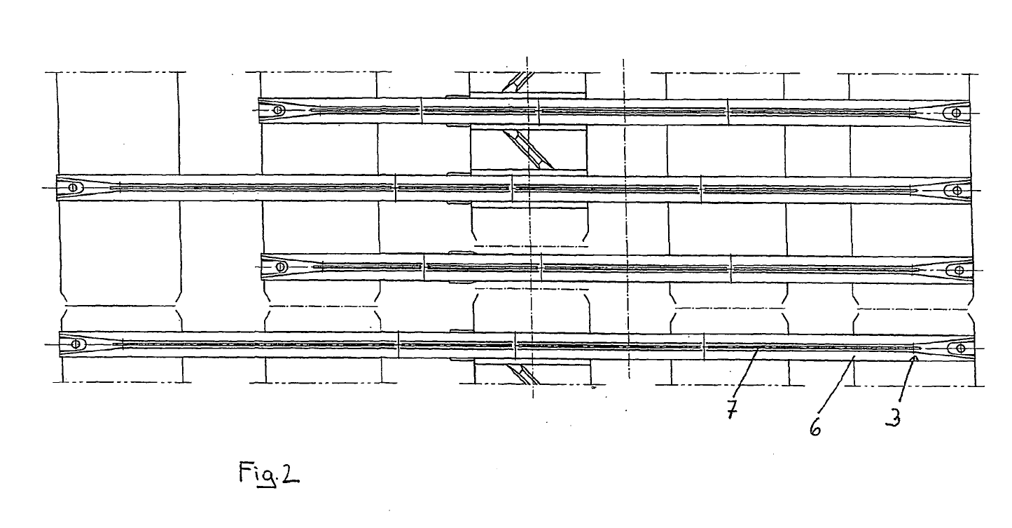

Referring now to FIG. 2 there is illustrated an example embodiment of a crawler 2 in accordance with the invention featuring studs 3 differingly arranged and differing in length. In this case, the sprocket 4 does not mesh in the middle but possibly to the right and/or left thereof, for example. In the example embodiment it is favorable to provide the mesh particularly to the right of the middle.

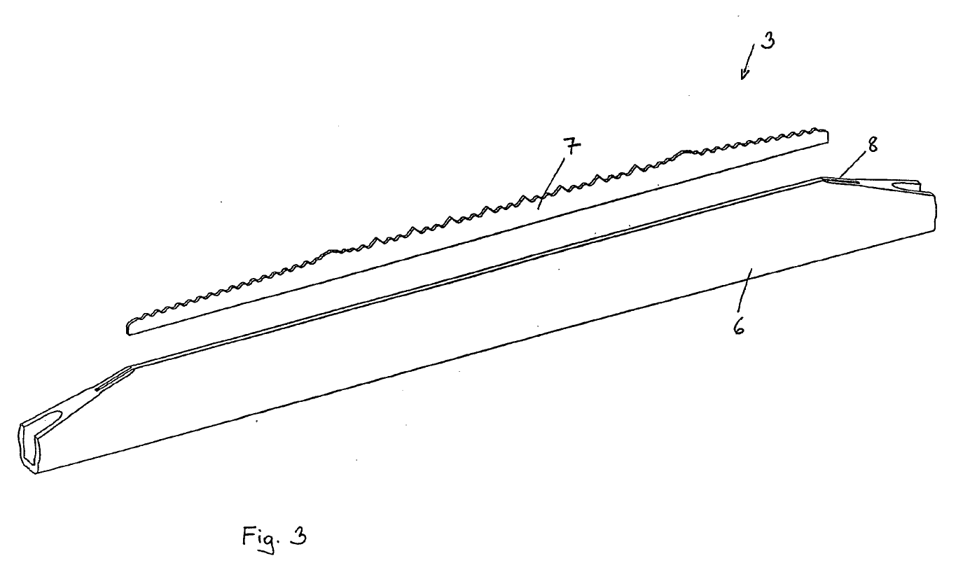

Referring now to FIG. 3 there is illustrated a bar 7 as a so-called toothed bar 7 comprising a jagged edge for improved traction of the vehicle in snow and ice. In this embodiment variant the bar 7 is inserted into the mounting portion 8 of the carrier 6 and is bonded in place at least partially.

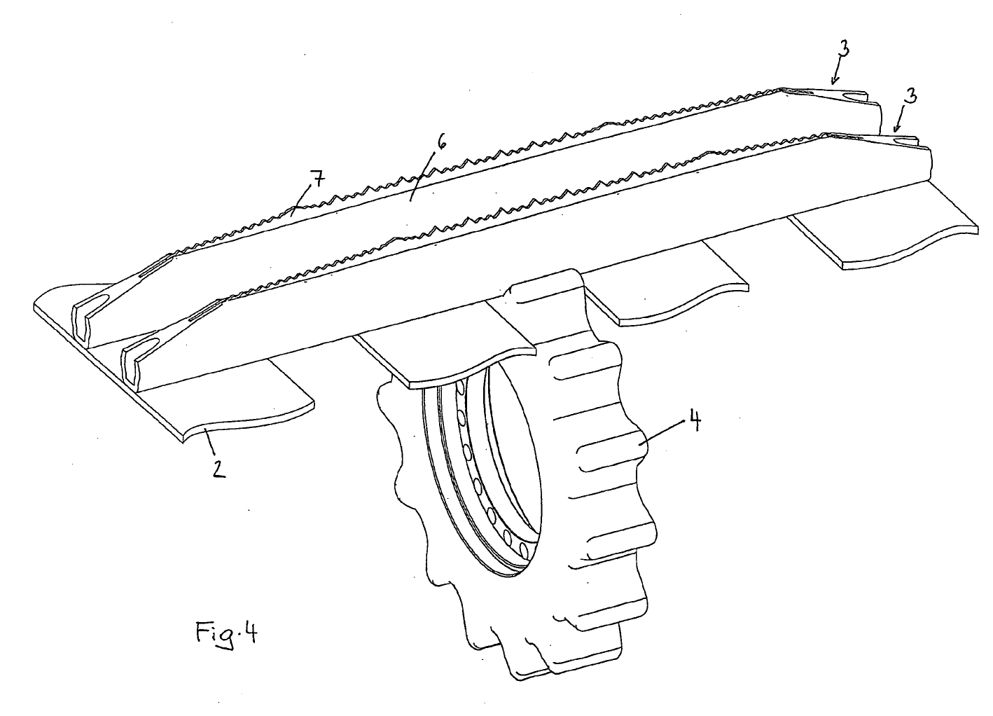

Referring now to FIG. 4 there is illustrated an example embodiment of a crawler 2 where the sprocket 4 meshes with the middle of the stud 3, this also being the portion where the mechanical stress of the bar 7 is highest due to loading by the sprocket 4. Now, bonding and/or welding the bar 7 in accordance with the invention favorably prevents breakage of such a stud 3 unlike other studs where likewise mechanical fasteners 10 are applied.

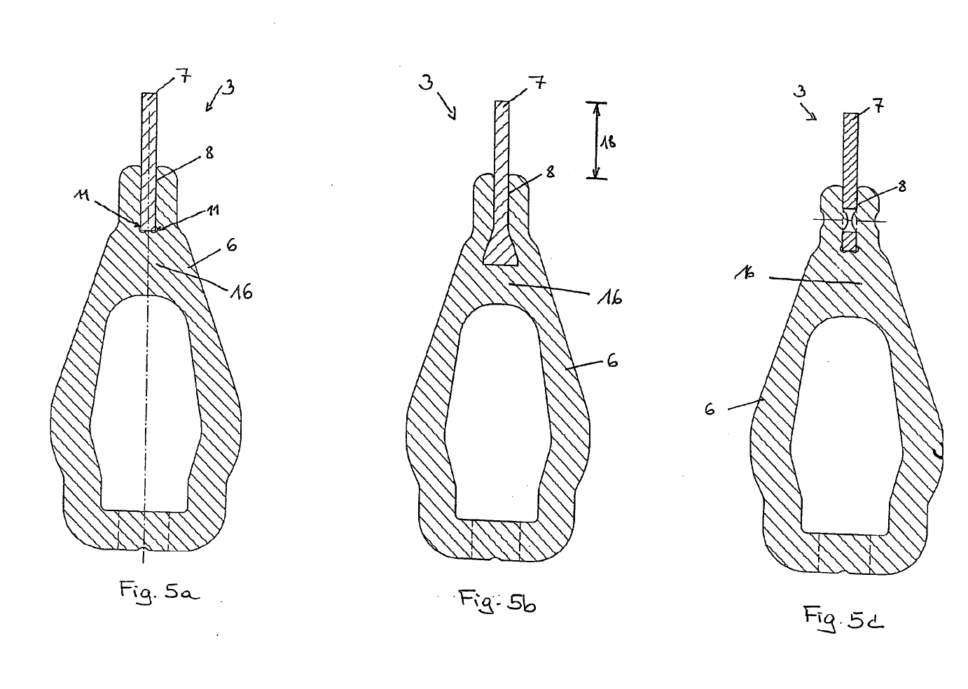

Referring now to FIGS. 5a-c there are illustrated three example embodiments for inserting the bar 7 in the mounting portion 8 of the carrier 6. FIG. 5a shows a roughly U-shaped groove into which the bar 7 is inserted from above, the recess 11 providing room for applying an adhesive, for instance. It is to be noted, however, that such a portion 11 is not a mandatory requirement, because the adhesive needs to be applied merely as a thin film. FIGS. 5b and 5c show two example embodiments of the bar 7 inserted positively connected, in addition to which further toxing or clinching the bar 7 to the mounting portion 8 of the carrier 6 is provided for in accordance with the invention. It may also be favorable when the bar 7 is configured tapered upwards in the exposed portion to facilitate the bite of the bar 7 in ice and snow. It is generally provided for in the preferred example embodiments that the bar 7, the same as shown in the other Figs. protrudes from the carrier so that the bar 7 bites in the snow or ground in operation of the crawler-type vehicle 1. As compared to the overall height of the bar 7 the portion 18 protruding from the carrier is preferably in the range 15 to 75%, particularly preferred being 25 to 50%.

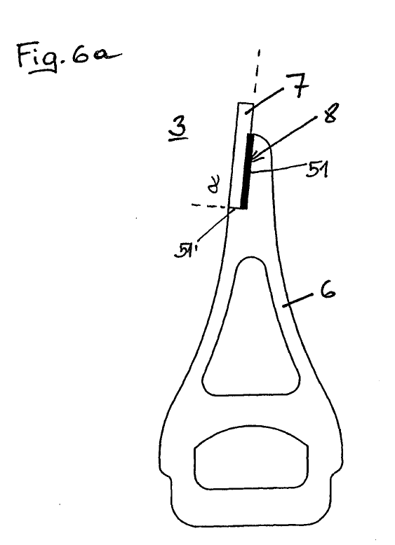

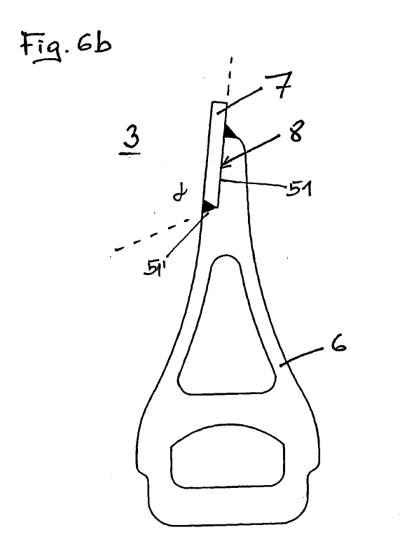

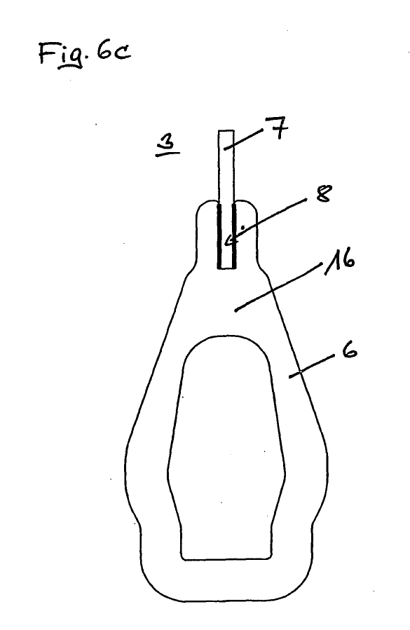

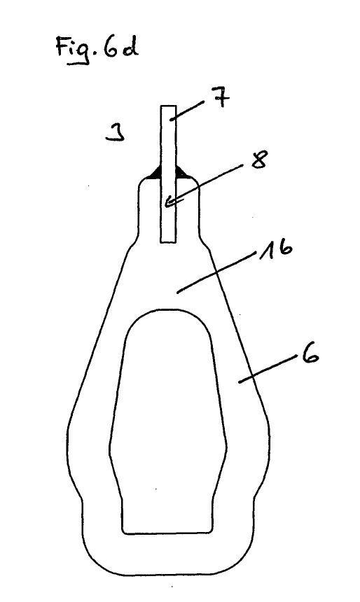

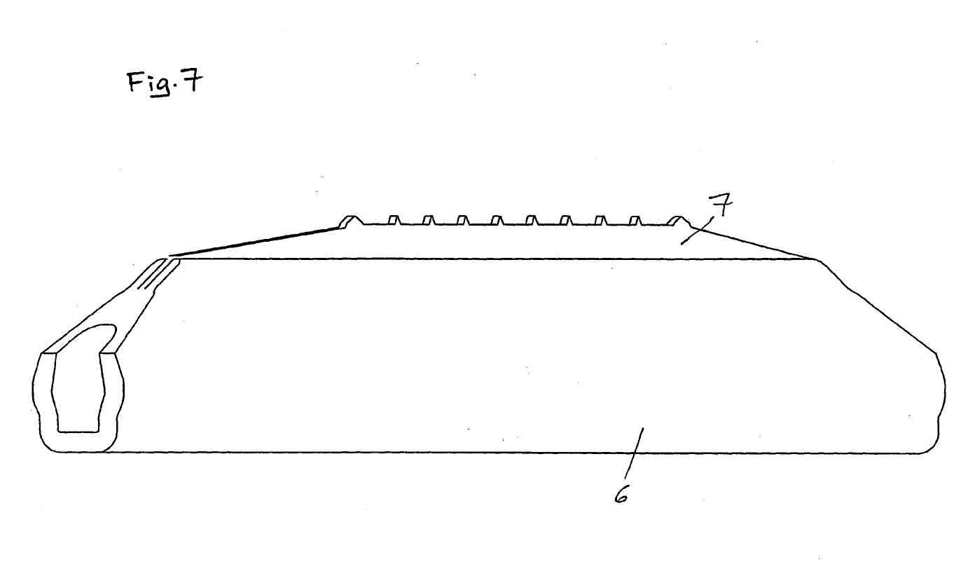

Referring now to FIG. 6a there is illustrated a stud in accordance with the invention with a welded bar 7. The bar 7 is located by two legs 51, 51′ in the mounting portion 8, it being fixedly connected by a friction welding to one leg 51. Referring now to FIG. 6b there is illustrated likewise an example embodiment of a stud 3 in which the bar 7 is located by two legs 51, 51′ in the mounting portion 8, except that in this case the bar 7 is fixedly connected by a CMT weld. The welds in both cases (FIGS. 6a and 6b) are indicated bold. It is, of course, just as possible in both variants that the bar 7 additionally comprises bonded connections. The angle a as shown in FIG. 6a is 90° whereas in FIG. 6b it exceeds 90°, it being roughly 120°. Favorable the angle α is in the range of roughly 90° to 150° (the angle α is represented by the broken lines). FIGS. 6c and 6d each show two further example embodiments of studs 3 having a U-shaped groove as the mounting portion 8 inserted in the 7. In FIG. 6c the connection between the carrier 6 and bar 7 is made by friction welding, whilst in FIG. 6d the connection is a CMT weld. To further enhance the rugged connection friction welding and CMT welds may also be combined.

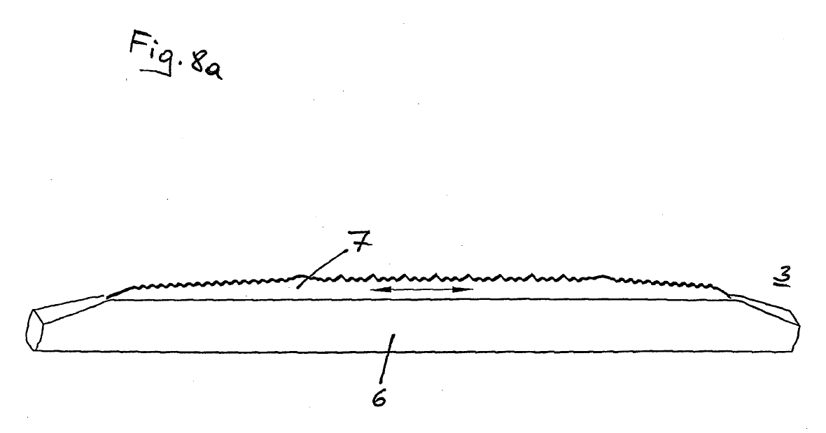

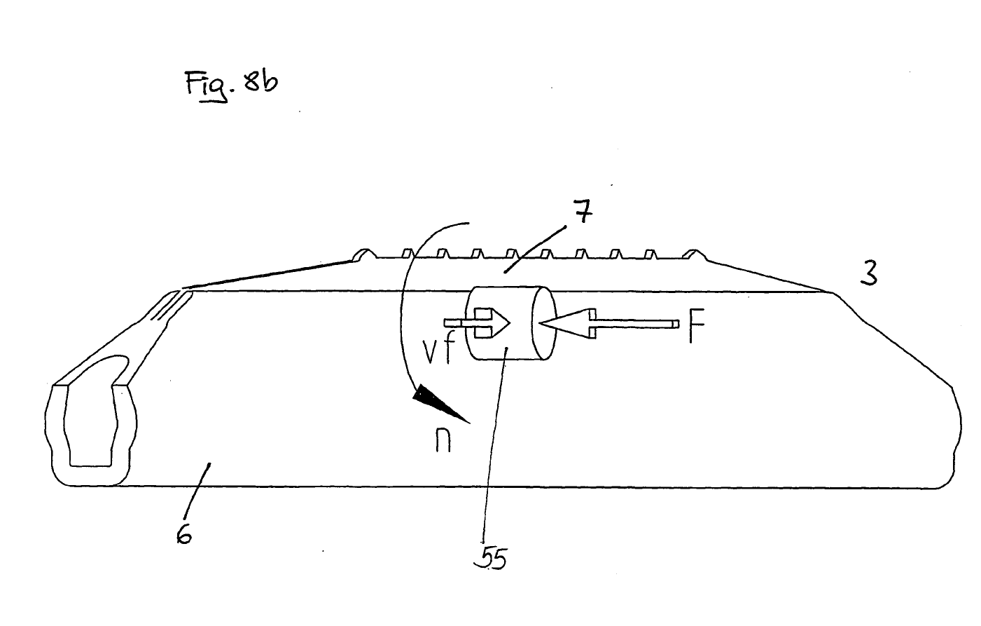

Referring now to FIG. 7 there is illustrated a bar in the form of a toothed bar 7 inserted in the carrier 6 before being friction welding. In this case it is necessary that the bar 7 is located in the carrier 6 not too loosely so that the flutter of the bar 7 in the carrier 6, as indicated by the double arrow, results in the two components connecting at a certain frequency as evident from FIG. 8a, i.e. the flutter of the bar 7 in the carrier 6 must occur at a frequency to achieve a sufficiently high friction temperature at which bar 7 and carrier 6 become welded. In the preferred example embodiment the bar 7 is made of steel and the carrier 8 is made of aluminum.

Referring now to FIG. 8b there is illustrated a further embodiment of the friction welding in which a punch 55 applied from without is rotated at high speed (at approx. 20,000 rpm depending on the variant involved) and urged against the stud 7 with a defined force F. Optionally the temperature of the bar and/or carrier can be dictated by a heater, resulting in the light alloy becoming “doughy” and welded to the steel. The punch 55 is advanced at a speed vf over the stud, preferably along the mounting portion 8.

The advantages resulting from application of CMT welding requiring a reduced heat input are e.g. less distortion and better welding accuracy. CMT welding differs from known methods of short arc welding on three decisive counts: wire movement is involved in process control, reduced heat input and splatterless material transition. Whenever a short-circuit occurs the digital process controller interrupts the power input. This advance/retract motion occurs at a frequency of up to 70 Hz, which also promotes drop release.

1. A stud for a crawler pertaining to crawler-type vehicles, especially ski slope grooming vehicles or appliances for tracing cross-country ski runs, comprising a carrier with a portion for mounting an inserted bar, said mounting portion comprising two substantially parallel legs interconnected by a connecting element arranged spaced away from the contact surface of the stud on the crawler by a spacing (d), wherein the bar is bonded and/or welded at least partially in the mounting portion.

2. A stud for a crawler pertaining to crawler-type vehicles, especially ski slope grooming vehicles or appliances for tracing cross-country ski runs, comprising a carrier with a portion for mounting an inserted bar, said mounting portion comprising at least two legs at an angle a to each other, wherein the bar is bonded and/or welded at least partially to the mounting portion.

3. The stud as set forth in claim 2, wherein the bar is in contact with the two legs at least portionwise.

4. The stud as set forth in claim 1, wherein the two legs and the connecting element form substantially a U-shaped groove cross-sectionally.

5. The stud as set forth in claim 4, wherein the bar extends down to the bottom of the groove.

6. The stud as set forth in claim 1, wherein the bar is connected to the mounting portions without mechanical fasteners.

7. The stud as set forth in claim 1, wherein the insertion depth of the bar in the mounting portions of the carrier is smaller than roughly a third of the height (h) of the carrier, preferably smaller than a fifth of the height (h) of the carrier.

8. The stud as set forth in claim 1, wherein the bar is inserted at least partially in the mounting portion of the carrier positively connected.

9. The stud as set forth in claim 1, wherein the bar is inserted in the mounting portion of the carrier friction-locked at least partially.

10. The stud as set forth in claim 1, wherein a chemically hardening adhesive is used as the adhesive.

11. The stud as set forth in claim 8, wherein an anaerobic hardening adhesive is used as the adhesive.

12. The stud as set forth in claim 1, wherein the bar and the carrier are interconnected at least partially by additional connections, particularly by toxing or clinching.

13. A crawler-type vehicle, especially ski slope grooming vehicle or appliance for tracing cross-country ski runs, comprising a crawler having a stud and at least one sprocket for the crawler, wherein the stud is configured in accordance with claim 1.

14. A method of producing a stud for a crawler pertaining to type-type vehicles, especially ski slope grooming vehicles or appliances for tracing cross-country ski runs, comprising a carrier with a portion for mounting an inserted bar, particularly as set forth in claim 1, bar and carrier being made of differing materials, particularly metals or alloys, wherein the bar is welded to the carrier.

15. The method as set forth in claim 14, wherein the carriers is substantially made of aluminum and the bar is substantially made of steel.

16. The method as set forth in claim 14, wherein the bar is welded to the carrier by friction welding and/or CMT welding.
